(19) United States
(12) Patent Application Publication
(10) Pub. No.: US 2017/0116592 A1
(43) Pub. Date: Apr. 27, 2017

(54) PAYMENT SYSTEM

(71) Applicant: SETOMATIC SYSTEMS INC., FARMINGDALE, NY (US)

(72) Inventor: MICHAEL SCHANTZ, BELLMORE, NY (US)

(73) Assignee: SETOMATlC SYSTEMS INC., FARMINGDALE, NY (US)

(21) Appl. No.: 14/924,193

(22) Filed: Oct. 27, 2015

(51) Int. Cl. G06Q 20/26; G06Q 20/40

(52) U.S. Cl. CPC G06Q 20/26; G06Q 20/405

(57) ABSTRACT

An apparatus comprising a communications interface, and a processor configured to: receive, via the communications interface, a request to authorize a service provided by an operator, and payment information associated with a payment account; perform a search for a local debit account (LDA) that is associated with at least one of the payment information and an operator ID and/or a location ID associated with the operator; and in response to the LDA being identified as a result of the search, deduct a cost of the service from the LDA and transmit a response authorizing performance of the service.

### BACKGROUND

Technical Field

The present disclosure generally relates to electronic devices, in general, and, more particularly, to a payment system.

Description of the Related Art

Credit card and other automated transactions normally cost a service charge to the merchants who conduct them. This makes the use of credit cards in small-sum transactions untenable as the service charge may form a large portion of the transactions. Merchants who tend to conduct large numbers of small-sum transactions, such as laundry facilities at laundromats or apartment buildings, are particularly at a disadvantage because the service charges for those transactions may amount to a significant portion of the merchants' revenue. For this reason, such merchants are often forced to limit the number of payment methods they accept to the inconvenience of their customers. Accordingly, the need exists for a method and apparatus that lowers the cost of credit card and other automated transactions.

### SUMMARY

The present disclosure addresses this need. According to aspects of the disclosure, an apparatus is provided comprising a communications interface, and a processor configured to: receive, via the communications interface, a request to authorize a service provided by an operator, and payment information (which may include, for example, a location identification and/or a card number) associated with a payment account; perform a search for a local debit account (LDA) that is associated with at least one of the payment information and an operator ID associated with the operator; and in response to the LDA being identified as a result of the search, deduct a cost of the service from the LDA and transmit a response authorizing performance of the service. In the case where an operator has multiple locations, the operator may have multiple operator IDs that are associated with the particular operator and with each of the locations of the operator and/or there may be provided a location ID in addition to the operator ID.

According to aspects of the disclosure, a method is provided comprising: receiving, via a communications interface, a request to authorize a service provided by an operator, and payment information associated with a payment account; performing, by a processor, a search for a local debit account (LDA) that is associated with at least one of the payment information and an operator ID associated with the operator; and in response to the LDA being identified as a result of the search, deducting a cost of the service from the LDA and transmitting a response authorizing performance of the service.

### BRIEF DESCRIPTION OF THE DRAWINGS

FIG. 1 is a diagram of an example of a system, according to aspects of the disclosure;

FIG. 2 is a diagram of an example of a service device, according to aspects of the disclosure;

FIG. 3 is a diagram of an example of an account management server (AMS), according to aspects of the disclosure;

FIG. 4 is a diagram of an example of an account record, according to aspects of the disclosure;

FIG. 5 is flowchart of an example of a process, according to aspects of the disclosure;

FIG. 6 is a flowchart of an example of a sub-process associated with the process of FIG. 5, according to aspects of the disclosure; and

FIG. 7 is a sequence diagram of an example of a process, according to aspects of the disclosure.

FIG. 8 is a diagram of an example of a user interface, according to aspects of the disclosure.

### DETAILED DESCRIPTION

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present disclosure, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention. However, the order of description should not be construed to imply that these operations are order-dependent.

According to aspects of the disclosure, a method for conducting small-sum or small-ticket transactions (i.e., transactions below a predetermined monetary value) is provided in which a customer can use his/her credit card account or another payment account (e.g., a debit card account) to pay for a particular service. The method is suitable for use by businesses that tend to carry large numbers of small-sum transactions at laundry facilities, such as those at laundromats or apartment complexes, for example. According to the method, when a customer attempts to use his/her credit card to pay for a service for the first time, a local debit account (LDA) is created on behalf of the customer, and associated with the customer's credit card. Afterwards, the customer's credit card is charged for a sum that is greater than the cost of the service, and that sum is added to the customer's LDA. Finally, the cost of the service is deducted from the customer's LDA and the service is performed. Later on, when the customer attempts to obtain the service for a second time, the customer's LDA is charged without money being withdrawn from the customer's credit card or debit card or the like, as long as the amount of the transaction is less than the balance of the LDA.

For example, if the customer wishes to purchase a service (or article) that costs $2.50, an initial amount of $20 can be debited from the customer's credit card and transferred into the customer's LDA, after which the service cost is deducted from the LDA balance. The next time the customer attempts to purchase the same service, another charge of $2.50 may be applied to the customer's LDA directly without the customer's credit card account being used. Once the LDA balance falls below a predetermined value (e.g., a sum that is insufficient to purchase another wash and/or drying cycle), a new charge may be made to deposit additional funds to replenish the LDA balance. Using the customer's LDA instead of a credit card is advantageous to the operator providing the service because it minimizes the operator's transaction costs for charging the customer's credit card account.

According to aspects of the disclosure, the customer's LDA may be associated with the customer's credit card number in order to permit the customer to use his/her credit card to charge the local business account. Under this arrangement, the customer's credit card becomes the device that creates the account, accesses the account for transactions, and replenishes the account when its balance runs too low.

According to aspects of the disclosure, the customer's LDA may be automatically replenished when its balance falls below a threshold, and the customer attempts to pay for a service. For example, if the customer attempts to purchase a service by swiping his/her card, when the LDA's balance is too low, another sum that is larger than the service cost may be automatically debited from the customer's credit card and added to the balance of the LDA.

According to aspects of the disclosure, the only way to replenish the account may be to use the customer's credit card as no other information regarding the customer may be kept on file. This may make the LDA easier to manage and ensure extra protection of the customer's privacy. Also, in some implementations, the LDA may be automatically closed when it is not used for a predetermined period of time, and/or its balance falls below a threshold level without being replenished.

According to aspects of the disclosure, the customer's LDA may be operator-specific. Thus, for different operators, different LDAs may be created. Any operator may include a business that owns a service device providing service and/or a business branch. Any operator may be associated with an operator ID that can be used to retrieve a customer's LDA for that operator.

Furthermore, according to aspects of the disclosure, a web-based user interface may be provided for managing the customer's accounts. The user interface may list all LDAs that the customer has with different operators, and it may permit the customer to manage those LDAs.

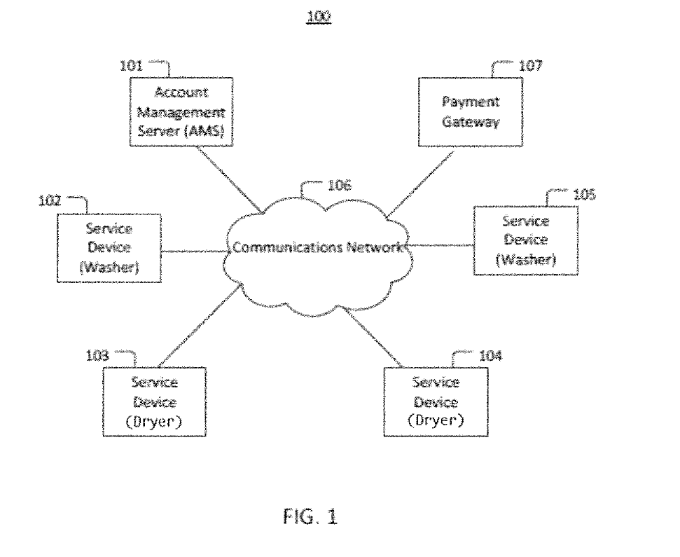

FIG. 1 is a diagram of an example of a system 100, according to aspects of the disclosure. As illustrated, the system 100 includes an account management server (AMS) 101, service devices 102-105, a communications network 106, and a payment gateway 107.

According to aspects of the disclosure, the AMS 101 may be any suitable type of computing device that is capable of hosting an account management database. In operation, the AMS 101 may execute payment transactions on behalf of the service devices 102-105 and/or authorize the performance of services by the service devices 102-105. The service devices 102-105 may include any suitable type of device that is capable of performing service in exchange for a payment. For example, the service devices 102-105 may include a washing machine, a clothes dryer machine, a parking meter, a vending machine, and/or any other suitable type of machine or device. In some implementations, any of the service devices 102-105 may include a built-in credit card reader that permits the device to receive directly payment for its services.

The communications network 106 may include one or more of a local area network (LAN), a wide area network (WAN), a wireless network (e.g., 802.11, 4G, etc.), and or any other suitable type of network. The payment gateway 107 may include any suitable type of system that is capable of authorizing credit card payments requested by the AMS 101. In some, the AMS 101 is connected to the service devices 102-105 and the payment gateway 107 via the communications network 106.

FIG. 2 is a diagram of an example of a service device 200, according to aspects of the disclosure. As illustrated, the service device 200 includes a processor 201, a communications interface 203, a memory 205, a payment device 207, and a mechanical and/or electronic appliance 209 for performing a service. According to aspects of the disclosure, the processor 201 may include any suitable type of processing circuitry, such as a general-purpose processor (e.g., an ARM-based processor), an application-specific integrated circuit (ASIC), or a Field-Programmable Gate Array (FPGA). The communications interface 203 may include any suitable type of communications interface, such as a WiFi interface, an Ethernet interface, a Long-Term Evolution (LTE) interface, a Bluetooth Interface, an Infrared interface, etc. The memory 205 may include any suitable type of volatile and non-volatile memory, such as random-access memory (RAM), read-only memory (ROM), flash memory, cloud storage, or network accessible storage (NAS), the memory 305, etc. The payment device 207 may include any suitable type of device that is capable of being used for receiving payment information (e.g., credit card reader), such as a Near-Field

Communications interface, a magnetic stripe credit card reader, a chip credit card reader, an optical scanner, a Bluetooth interface, a Radio Frequency Identifier (RFID) interface, etc. The appliance 209 may include any suitable type of electrical and/or mechanical appliance that is capable of performing a service, such as a washing machine, a clothes dryer machine, a parking meter, a vending machine, etc.

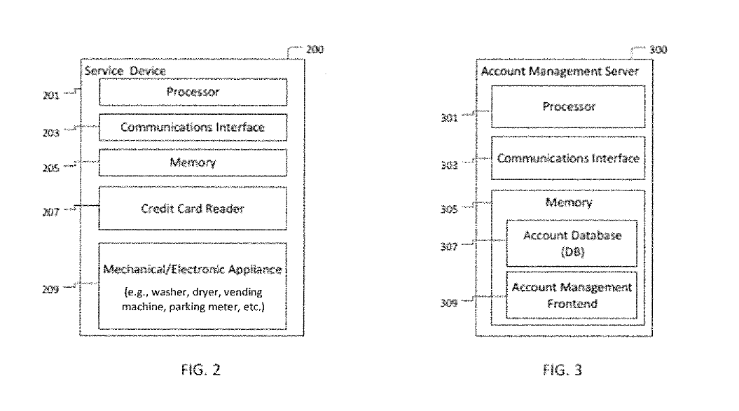

FIG. 3 is a diagram of an example of an account management server (AMS) 300, according to aspects of the disclosure. As illustrated, the AMS 300 includes a processor 301, a communications interface 303, and a memory 305. According to aspects of the disclosure, the processor 301 may include any suitable type of processing circuitry, such as a general-purpose processor (e.g., an ARM-based processor), an application-specific integrated circuit (ASIC), or a Field-Programmable Gate Array (FPGA). The communications interface 303 may include any suitable type of communications interface, such as a WiFi interface, an Ethernet interface, a Long-Term Evolution (LTE) interface, a Bluetooth Interface, an Infrared interface, etc. The memory 305 may include any suitable type of volatile and non-volatile memory, such as random-access memory (RAM), read-only memory (ROM), a hard disk (HD), a solid state drive (SSD), a CD-ROM, flash memory, cloud storage, or network accessible storage (NAS). In some implementations, the memory 305 may store a database 307 and an account management frontend 309. The database 307 may include any suitable type of data structure that is capable of storing account records, such as a file system folder, a relational database, an SQL database, etc.

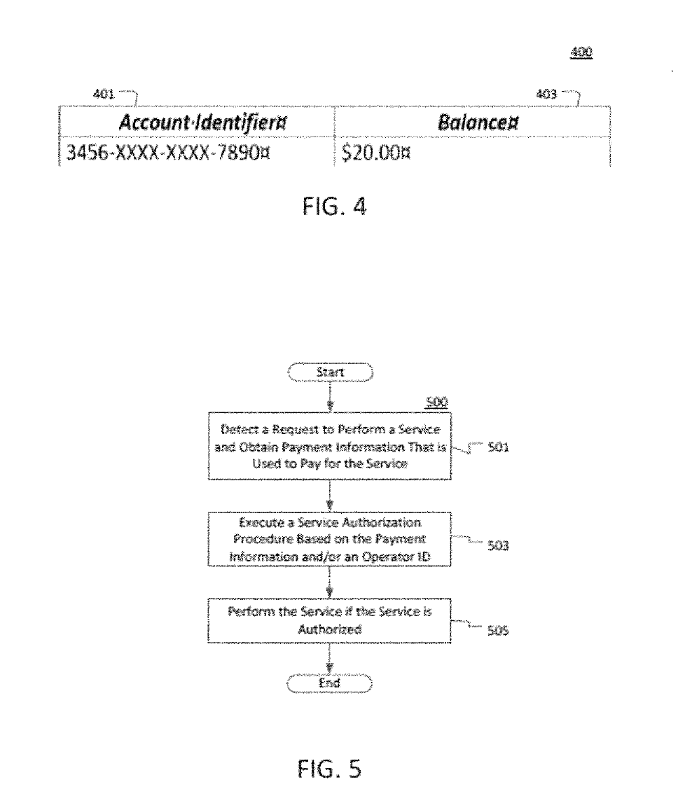

The database 307 may store one or more account records that are associated with different local debit accounts (LDAs). An example of an account record 400, which may be stored in the database 307, is shown in FIG. 4. As illustrated, the account record 400 may include an identifier field 401 and a balance field 403. The identifier field 401 may contain an identifier corresponding to the LDA that is associated with the account record 400. In the present example, the account identifier is the number (or portion thereof) of the credit card that is used to open the account. However, in some implementations, the account identifier may include any suitable number, string, and/or alphanumerical string that is capable of being used to identify the account and/or retrieve the account record 400 from the database 307. As the name suggests, the balance field 403 may include an indication of the LDA's current balance.

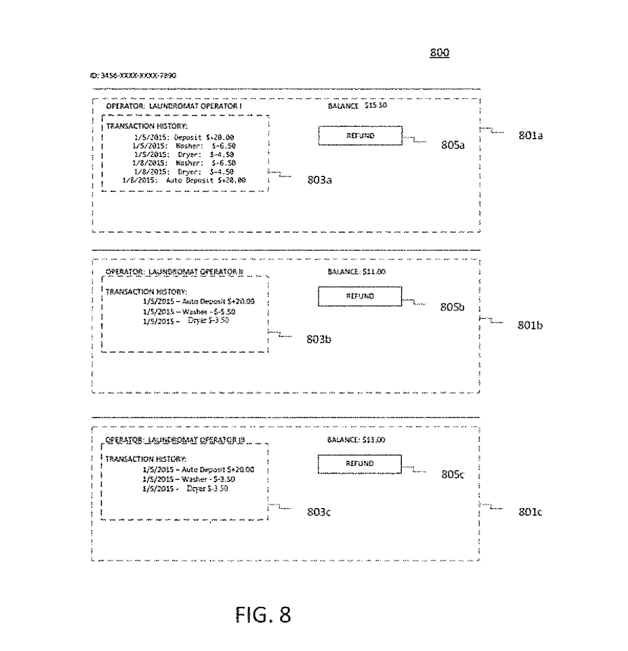

The account management frontend may include one or more processor-executable instructions, which when executed, cause the AMS 101 to provide an interface for managing one or more user applications. According to some implementations, the interface may be provided as an online service that is accessible via a web-browser, and/or a service that accessible by a dedicated standalone application (e.g., an Android App). An example of the user interface is discussed further below with respect to FIG. 8.

Although in this example the AMS 101 is presented as an integrated device, in some implementations the AMS 101 may be implemented as a network of computers. For instance, the database 307 and the account management frontend 309 may be hosted on different devices.

FIG. 5 is a flowchart of an example of a process 500, according to aspects of the disclosure.

In operation 501, a request for performing a service is detected along with payment information (e.g., a credit card number, a checking account number, etc.) that is associated with a particular payment account (e.g., a credit card account, a checking account, etc.). In some implementations, the request may be detected in response to the customer swiping his/her credit card through a credit card reader and/or transmitting payment information via various hardware and/or protocols including, for example, near field communication (NFC), radio-frequency identification (RFID), and/or smart chip or EMV technology or the like.

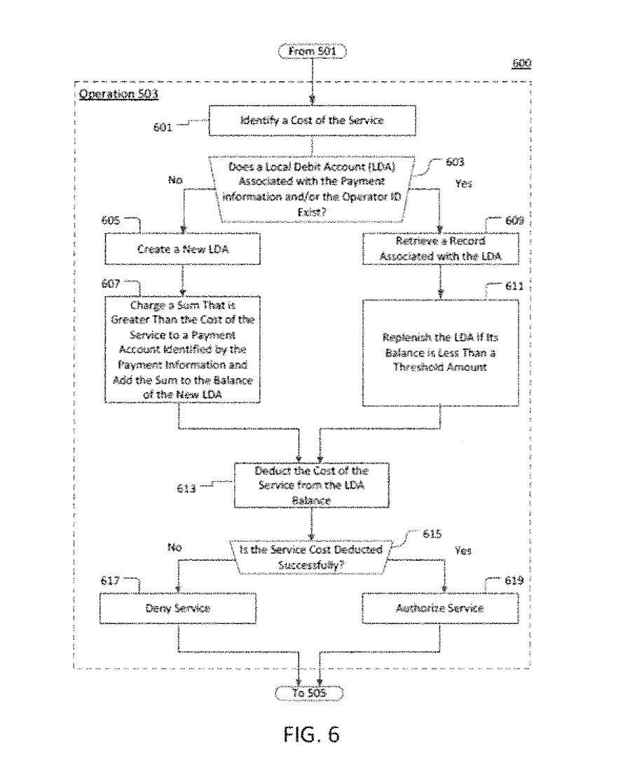

In operation 503, a procedure for authorizing the service is executed. Operation 503 is presented in further detail in the discussion provided with respect to FIG. 6.

In operation 505, the service is performed, if it is successfully authorized. In some implementations, performing the service may include generating one or more control signals which when received by an appliance cause the appliance to perform the service. As noted above, the service may include a executing a wash cycle, executing a dry cycle, dispensing an article, and/or issuing a parking receipt.

FIG. 6 is a flowchart of a sub-process 600 for executing an authorization procedure as specified by operation 503 of FIG. 5, according to aspects of the disclosure.

In operation 601, the cost of the service requested at operation 501 is identified. For example, the cost of the service may be $2.

In operation 603, a search of an account database is performed (e.g., a local or remote database) to determine whether a local debit account (LDA) exists that is associated with the payment information obtained at operation 501. The search may be performed based on the payment information and/or an identifier corresponding to an operator providing the service (e.g., an identifier corresponding to a laundromat operator, and/or identifier corresponding to a laundromat branch).

If the search fails to identify an LDA associated with the payment information, in operation 605, a new LDA associated with the payment information is created. Creating the new LDA may include generating a new account record, inserting at least a portion of the payment information in the identifier field of the new account record, and storing the new account record in an account database (e.g., the database 307). Afterwards, in operation 607, the payment account associated with the payment information (e.g., credit card account) is charged for an amount that is greater than the cost of the service, and the charged amount is added to the balance of the newly-created account. For example, the payment account may be charged $20, and this sum may be used to seed the new LDA.

In some implementations the initial amount that is charged to the payment account may be specified by the operator and/or determined dynamically based on at least one of the type of the payment information (e.g., credit card type, checking account type, etc.) or the cost of the service. For example, the initial charge may be a predetermined multiple of the service cost. Additionally or alternatively, the value of the multiplier may vary based on the type of the payment information.

If an LDA associated with the payment information exists, in operation 609, an account record associated with the LDA is retrieved from the account database. Afterwards, in operation 611, the remaining balance of the LDA is identified and the LDA is replenished if its remaining balance is below a predetermined threshold. According to aspects of the disclosure, replenishing the LDA may include charging the payment account associated with the payment information for a sum that is greater than the cost of the service, and the sum may then be added to the balance of the account. For example, the payment account may be charged $20, and that sum may be added to the balance of the LDA.

In operation 613, the cost of the service is deducted from the balance of the LDA identified at operations 605-607 or operations 609-611 (e.g., previously-existing or newly-created). In operation 615, a determination is made whether the deduction is completed successfully. If, for some reason, the deduction cannot be completed, in operation 617, authorization for the service is denied. Otherwise, if the cost of the service is successfully withdrawn from the balance of the account, in operation 619, authorization to perform the service is granted.

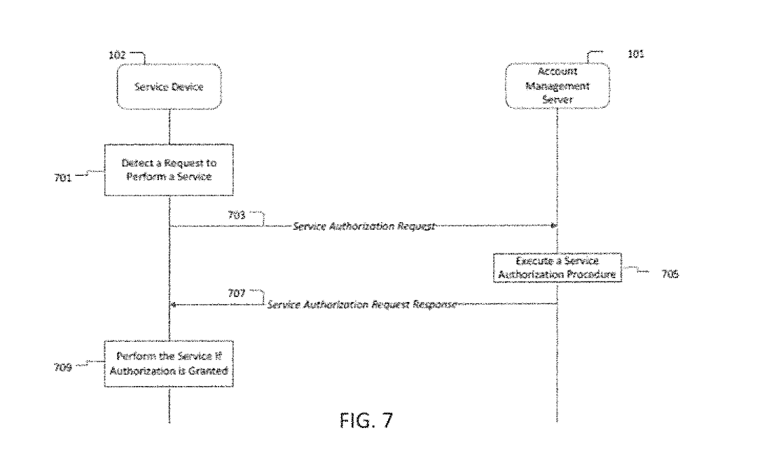

In some implementations, the process of FIGS. 5-6 may be performed entirely or substantially by a service device (e.g., the service device 102). Additionally or alternatively, in some implementations, the process of FIGS. 5-6 may be performed by a service device in cooperation with an AMS, as shown in FIG. 7. More particularly, FIG. 7 is a sequence diagram of an example of a process in which a service device and an AMS interact to provide a service, according to aspects of the disclosure.

In operation 701, the service device 102 detects a request for performing a service along with payment information (e.g., a credit card number, a checking account number, etc.) that is associated with a particular payment account (e.g., a credit card account, a checking account, etc.). In operation 703, the service device 102 transmits to the AMS 101 a service authorization request including the payment information and/or an indication of the type of requested service. In operation 705, the AMS 101 executes an authorization procedure (e.g., shown in FIG. 6) and determines whether to grant the authorization request. In operation 707, the AMS 101 transmits a response to the service authorization request. The response may indicate whether authorization to perform the service is granted. And finally, in operation 709, the service is performed, if the authorization is granted.

In some implementations, the AMS 101 may provide a web-based user interface for managing user accounts. FIG. 8 is a diagram of an example of a user interface 800 for managing the user accounts, according to aspects of the disclosure. As illustrated, the user interface 800 may identify a plurality of LDAs 801a-c, which a given customer has with different operators. Each of the accounts may be associated with the user's credit card number (or another payment account identifier). For each LDA 801, the user interface may provide a transaction history record 803 showing past transactions that were made using the account. In addition, for each LDA 801, the interface may provide a user interface component 805 (e.g., a button), which when activated causes the account management's server to refund the balance of the component's respective account back to the user's credit card (or another payment account).

For example, as shown in the illustrative example of LDA 801a, a user may initially deposit $20.00 on Jan. 5, 2015 and may subsequently purchase a washer operation on Jan. 5, 2015 for $6.50 and a dryer operation on Jan. 5, 2015 for $4.50. On Jan. 8, 2015, there is a sufficient balance in the LDA to purchase another washer operation for $6.50 but the subsequent purchase of $4.50 for a dryer operation triggers another $20.00 authorization to reload due to a low balance in the LDA, resulting in a new auto-deposit of $20.00, thereby permitting the Jan. 8, 2015 dryer transaction of $4.50 to be approved.

FIGS. 1-8 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

Having described at least one of the preferred embodiments of the present invention with reference to the accompanying drawings, it will be apparent to those of skill in the art that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An apparatus comprising a communications interface, and a processor configured to:
receive, via the communications interface, a request to authorize a service provided by an operator, and payment information associated with a payment account;
perform a search for a local debit account (LDA) that is associated with at least one of the payment information and an operator ID associated with the operator; and
in response to the LDA being identified as a result of the search, deduct a cost of the service from the LDA and transmit a response authorizing performance of the service.

2. The apparatus of claim 1, wherein the processor is further configured to, in response to the search failing to identify the LDA, create a new LDA associated with the payment information, charge to the payment account a sum that is greater than the cost of the service, credit the sum to the new LDA, deduct the cost of the service from the new LDA, and transmit a response authorizing performance of the service

3. The apparatus of claim 1, wherein the search for the LDA is performed based on both the payment information and the operator ID.

4. The apparatus of claim 1, wherein the payment information includes a credit card number.

5. The apparatus of claim I, wherein performing the service includes at least one of executing a wash cycle by a washing machine and executing a dry cycle by a clothes dryer machine.

6. A system for performing a service, comprising a payment information reader, an appliance, and a processor configured to:
detect, via the payment information reader, payment information associated with a payment account;
perform a search for a local debit account (LDA) that is associated with at least one of the payment information and an operator ID corresponding to an operator of the system; and
in response to the LDA being identified as a result of the search, deduct a cost of the service from the LDA and cause the appliance to perform the service.

7. The system of claim 6, wherein the processor is further configured to, in response to search failing to identify the LDA, create a new LDA associated with the payment information, charge to the payment account a sum that is greater than the cost of the service, credit the charged sum to the new LDA, deduct the cost of the service from the new LDA, and cause the appliance to perform the service.

8. The system of claim 6, wherein the search for the LDA is performed based on both the payment information and the operator ID.

9. The system of claim 6, wherein the payment information reader includes at least one of a credit card reader, a Near-Field Communications (NFC) interface, a Bluetooth interface, or a Radio Frequency Identifier (RFID) interface.

10. The system of claim 6, wherein the appliance includes at least one of a washing machine, a clothes dryer machine, a vending machine, and a parking meter.

11. A method comprising:
receiving, via a communications interface, a request to authorize a service provided by an operator, and payment information associated with a payment account;
performing, by a processor, a search for a local debit account (LDA) that is associated with at least one of the payment information and an operator ID associated with the operator; and
in response to the LDA being identified as a result of the search, deducting a cost of the service from the LDA and transmitting a response authorizing performance of the service.

12. The method of claim 11, further comprising, in response to the search failing to identify the LDA, creating a new LDA associated with the payment information, charging to the payment account a sum that is greater than the cost of the service, crediting the sum to the new LDA, deducting the cost of the service from the new LDA, and transmitting a response authorizing performance of the service.

13. The method of claim 11, wherein the search for the LDA is performed based on both the payment information and the operator ID.

14. The method of claim 11, wherein the payment information includes a credit card number.

15. The method of claim 11, wherein performing the service includes at least one of executing a wash cycle by a washing machine and executing a dry cycle by a clothes dryer machine.

16. A method for performing a service, comprising:
detecting, via a payment information reader, payment information associated with a payment account;
performing, by a processor, a search for a local debit account (LDA) that is associated with at least one of the payment information and an operator ID corresponding to an operator of an appliance; and
in response to the LDA being identified as a result of the search, deduct a cost of the service from the LDA and cause the appliance to perform the service.

17. The method of claim 16, further comprising, in response to the search failing to identify the LDA, creating a new LDA associated with the payment information, charging to the payment account a sum that is greater than the cost of the service, crediting the sum to the new LDA, deducting the cost of the service from the new LDA, and causing the appliance to perform the service.

18. The method of claim 16, wherein the search for the LDA is performed based on both the payment information and the operator ID.

19. The method of claim 16, wherein the payment information reader includes at least one of a credit card reader, a Near-Field Communications (NFC) interface, a Bluetooth interface, or a Radio Frequency Identifier (RFID) interface.

20. The method of claim 16, wherein the appliance includes at least one of a washing machine, a clothes dryer machine, a vending machine, and a parking meter.
